(19) United States
(12) Patent Application Publication
(10) Pub. No.: US 2024/0413714 A1
(43) Pub. Date: Dec. 12, 2024

(54) ELECTRIC POWER TOOL

(71) Applicant: BASSO INDUSTRY CORP., Taichung (TW)

(72) Inventors: Yu-Ming CHAN, Taichung (TW); Min-Hsu TSAI, Taichung (TW); Yi-Ting LAI, Taichung (TW)

(73) Assignee: BASSO INDUSTRY CORP., Taichung (TW)

(21) Appl. No.: 18/680,106

(22) Filed: May 31, 2024

(30) Foreign Application Priority Data
Jun. 8, 2023 (TW) 112121485

(51) Int. Cl. H02K 11/30; H02K 7/00; H02K 7/14; H02K 11/20

(52) U.S. Cl. CPC H02K 11/30; H02K 7/003; H02K 7/145; H02K 11/20

(57) ABSTRACT

An electric power tool includes a housing, a motor disposed in the housing, an output shaft connected to the motor and extending out of the housing, a magnetic ring sleeved on the output shaft, a magnetic polarity detector circuit disposed in proximity to the magnetic ring, and a controller connected to the motor and the magnetic polarity detector circuit. The output shaft is driven by the motor to rotate about its axis. The magnetic ring synchronously rotates with the output shaft, and has magnetic portions surrounding the output shaft. Every adjoining two of the magnetic portions have different magnetic polarities. The magnetic polarity detector circuit detects a change of magnetic polarities. The controller controls the motor to stop operating when an inter-change time interval satisfies a predetermined condition.

### CROSS-REFERENCE TO RELATED APPLICATION

This application claims priority to Taiwanese Invention Patent application Ser. No. 11/212,1485, filed on Jun. 8, 2023, and incorporated by reference herein in its entirety.

### FIELD

The disclosure relates to an electric power tool, and more particularly to an electric power tool with torque control.

### BACKGROUND

When an electric power tool (e.g., an impact wrench or an impact screw driver) is used to tighten a fastener (e.g., a bolt, a screw, and so on) and a bottom portion of the fastener is coplanar with a surface of a work piece, if a user of the electric power tool keeps pressing a trigger of the electric power tool to keep a motor of the electric power tool running for tightening the fastener, the fastener may be overtightened and the work piece may even be broken under an excessive torque exerted by the electric power tool.

Conventional approaches to control a torque exerted by the electric power tool include: stopping the motor when a detected electric current of the motor has reached a preset threshold or when the electric power tool has been used to tighten the fastener for a preset time period; and utilizing various kinds of sensors to detect physical characteristics (e.g., sounds, oscillations, deformations, and so on) caused by tightening the fastener and controlling the torque based on the detection thus made. However, the aforementioned conventional approaches require hardware (e.g., a controller) to perform complicated computations based on the detection. Moreover, uncertain conditions that are related to working environment and material of the work piece may mislead the controller into determining an incorrect state of how the fastener has been tightened.

### SUMMARY

Therefore, an object of the disclosure is to provide an electric power tool that can alleviate at least one of the drawbacks of the prior art.

According to the disclosure, the electric power tool includes a housing, a motor, an output shaft, a magnetic ring, a magnetic polarity detector circuit, and a controller.

The motor is disposed in the housing.

The output shaft is connected to the motor, extends out of the housing, and is configured to be driven by operation of the motor to rotate about its own axis.

The magnetic ring is sleeved on the output shaft so as to synchronously rotate with the output shaft. The magnetic ring has a plurality of magnetic portions surrounding the output shaft. Every adjoining two of the magnetic portions have different magnetic polarities.

The magnetic polarity detector circuit is disposed at a predetermined position in proximity to the magnetic ring. The magnetic polarity detector circuit is configured to detect a change of magnetic polarities at the predetermined position.

The controller is signally connected to the motor and the magnetic polarity detector circuit. The controller is configured, when the magnetic ring synchronously rotates with the output shaft that is driven by operation of the motor, to control the motor to stop operating when an inter-change time interval between two occurrence time spots at which two respective changes of magnetic polarities were detected by the magnetic polarity detector circuit satisfies a predetermined condition.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view illustrating an electric power tool according to an embodiment of the disclosure.

FIG. 2 is a perspective view partially illustrating the electric power tool according to an embodiment of the disclosure.

FIG. 3 is a block diagram illustrating the electric power tool according to an embodiment of the disclosure.

FIGS. 4 and 5 are schematic diagrams cooperatively illustrating operations of a magnetic ring and a magnetic polarity detector circuit of the electric power tool according to an embodiment of the disclosure.

FIG. 6 is a schematic diagrams illustrating a waveform of a detection signal.

FIG. 7 is a schematic diagrams illustrating a relationship between a duty ratio and a depth to which a trigger of the electric power tool is pressed according to an embodiment of the disclosure.

FIG. 8 is a flow chart illustrating a procedure of operating the electric power tool according to an embodiment of the disclosure.

### DETAILED DESCRIPTION

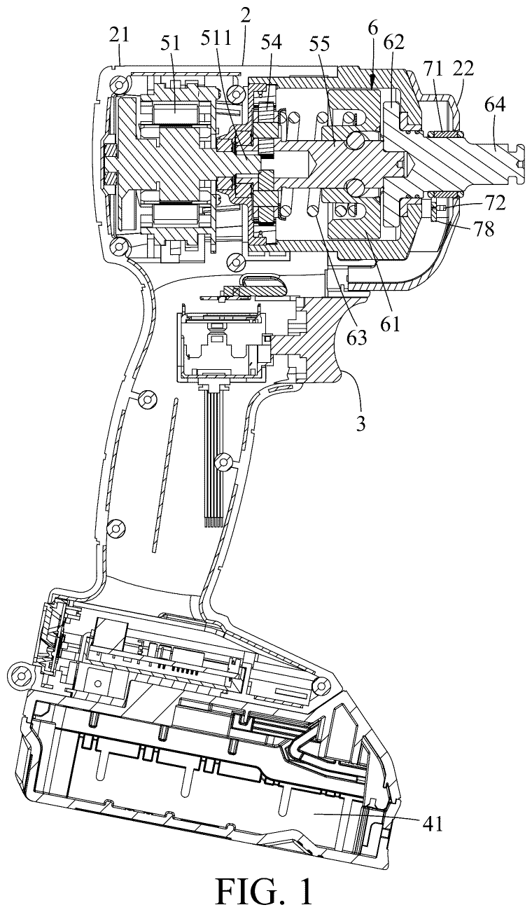

Referring to FIGS. 1 to 3, an embodiment of an electric power tool according to the disclosure is illustrated. The electric power tool includes a housing 2, a trigger 3, a power supply 4, a driving unit 5, an impact unit 6, a detection unit 7, and a controller 8.

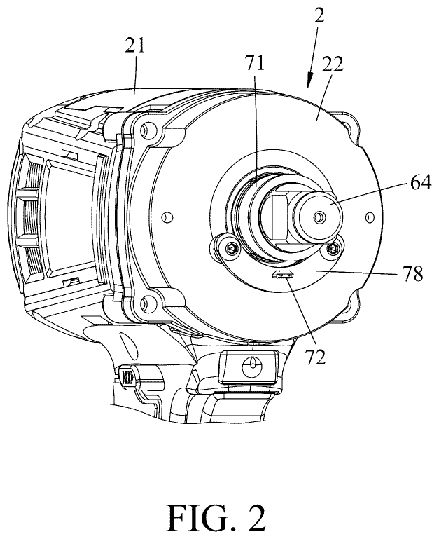

The housing 2 includes a casing 21, and a front cover 22 (see FIGS. 1 and 2) that is located at a front portion (at a right side of FIG. 1) of the housing 2.

The trigger 3 is disposed on the housing 2, and is configured to be pressed by a user to control the driving unit 5.

The power supply 4 includes a battery 41 that is disposed on the housing 2, and a power circuit 42 that is electrically connected to the battery 41. The power circuit 42 is configured to perform voltage regulation and voltage transformation on electricity supplied by the battery 41 to generate a desired electric power, and to supply the desired electric power to other components of the electric power tool. The power circuit 42 may be exemplarily implemented to include a low-dropout regulator (LDO) (not shown) for providing stabilized electricity.

The driving unit 5 includes a spindle 55, a speed-reduction mechanism 54, a motor 51 that is disposed in the housing 2, a driving circuit 52 that is electrically connected to the controller 8, and a switching circuit 53 that is electrically connected to the motor 51 and the driving circuit 52.

The motor 51 may be exemplarily implemented by a brushless direct current motor (BLDC). The motor 51 includes a motor shaft 511. The driving circuit 52 is configured to receive a pulse-width modulation (PWM) signal outputted by the controller 8, and to control, according to a duty ratio of the PWM signal, the switching circuit 53 to drive to motor 51 to rotate at a preset rotational speed (specifically, the motor shaft 511 rotates at the preset rotational speed). The switching circuit 53 may be implemented to include a metal-oxide-semiconductor field-effect transistor (MOSFET). The speed-reduction mechanism 54 is connected between the motor shaft 511 and the spindle 55. The speed-reduction mechanism 54 is configured to be driven by the motor 51 via the motor shaft 511 to control the spindle 55 for further driving the impact unit 6 in a manner that the spindle 55 rotates at a reduced rotational speed that is less than the preset rotational speed in which the motor shaft 511 rotates. The speed-reduction mechanism 54 may be implemented by an epicyclic gearing.

The impact unit 6 includes a helical spring 63, a hammer block 61 that is connected to the spindle 55, an anvil 62 that is separably connected to the hammer block 61, and an output shaft 64 that is disposed on the anvil 62, that is connected to the motor 51 and that extends out of the housing 2. A fastener (e.g., a drill, a screw, a bolt, and so on) is adapted to be disposed on the output shaft 64.

The output shaft 64 is configured to be driven by operation of the motor 51 to rotate about its own axis. Specifically, the hammer block 61 is configured to be driven, through the spindle 55 and the speed-reduction mechanism 54, by the motor shaft 511 to rotate, and the hammer block 61 that is being driven to rotate further drives the anvil 62 and the output shaft 64 to rotate. In this way, a rotational force exerted by the motor shaft 511 is converted into a rotational impact force. Since structures and operations of the driving unit 5 and the impact unit 6 have been well known to one skilled in the relevant art, detailed explanation of the same is omitted herein for the sake of brevity.

The detection unit 7 includes a magnetic ring 71, a magnetic polarity detector circuit 72, a panel interface circuit 73, a rotational-speed detecting circuit 74, a motor-current detecting circuit 75, a trigger detecting circuit 76, a battery detecting circuit 77, a circuit board 78 and a sensing resistor 79.

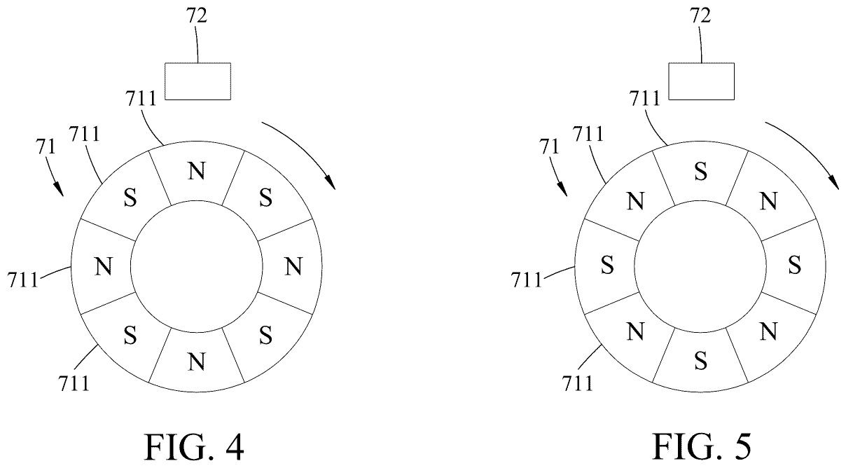

Referring to FIGS. 2, 3 and 4, the magnetic ring 71 is sleeved on the output shaft 64 so as to synchronously rotate with the output shaft 64. The magnetic ring 71 has a plurality of magnetic portions 711 surrounding the output shaft 64. Every adjoining two of the magnetic portions 711 have different magnetic polarities, i.e., north magnetic poles and south magnetic poles are alternated with each other. In this embodiment as shown in FIG. 4, the magnetic ring 71 has eight magnetic portions 711, and four of the magnetic portions 711 are north magnetic poles and another four of the magnetic portions 711 are south magnetic poles. However, a number of the magnetic portions 711 is not limited to the disclosure herein and may vary based on actual needs (e.g., for enhancing precision) in other embodiments.

The magnetic polarity detector circuit 72 is disposed at a predetermined position in proximity to the magnetic ring 71. In particular, the circuit board 78 is disposed at the predetermined position, and the magnetic polarity detector circuit 72 is disposed on the circuit board 78. In one embodiment, as shown in FIGS. 1 and 2, the circuit board 78 is arc-shaped, and surrounds the output shaft 64. Therefore, the magnetic polarity detector circuit 72 is also near the output shaft 64. However, a position of the magnetic polarity detector circuit 72 is not limited to the disclosure herein and may vary in other embodiments. The magnetic polarity detector circuit 72 may be exemplarily disposed on the housing 2 or may be positioned in a manner that the magnetic polarity detector circuit 72 is near both of the output shaft 64 and the magnetic ring 71.

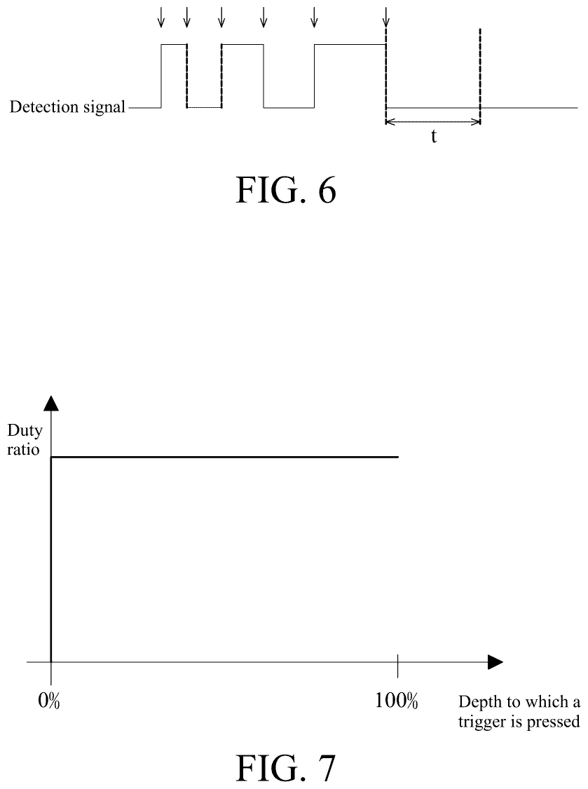

The magnetic polarity detector circuit 72 may be implemented by a Hall sensor. The magnetic polarity detector circuit 72 is configured to detect a change of magnetic polarities at the predetermined position. Referring to FIGS. 4, 5, and 6, due to rotation of the magnetic ring 71, one of the magnetic portions 711 that is most adjacent to the magnetic polarity detector circuit 72 would alternate the north magnetic pole and the south magnetic pole, and a detection signal generated by the magnetic polarity detector circuit 72 would exemplarily have a waveform as shown in FIG. 6. When a most adjacent one of the magnetic portions 711 having the north magnetic pole as shown in FIG. 4 changes to another most adjacent one of the magnetic portions 711 having the south magnetic pole as shown in FIG. 5, the magnetic polarity detector circuit 72 would detect such change of magnetic polarities, and the detection signal would thereby show a transition as indicated by one of arrows in the waveform. It should be noted that an arrow in FIG. 6 represents a respective one of changes of magnetic polarities.

The panel interface circuit 73 is disposed on the housing 2 (not shown). The panel interface circuit 73 is electrically connected to the controller 8. The panel interface circuit 73 may be implemented to include knob(s), physical button(s), a combination of physical button(s) and a screen, or a touchscreen. The panel interface circuit 73 is configured to be operated by a user, to generate setting data based on user input, and to send the setting data to the controller 8. For example, in a scenario where the panel interface circuit 73 is implemented to be a touchscreen, the panel interface circuit 73 is capable of displaying a prompt to request the user to select an operation mode of the electric power tool, and generating and sending to the controller 8 setting data related to configuring the electric power tool to operate in the operation mode selected by the user based on a user input.

The rotational-speed detecting circuit 74 is positioned adjacent to the motor 51. The rotational-speed detecting circuit 74 is exemplarily implemented by a Hall sensor. The rotational-speed detecting circuit 74 is configured to detect a position of a rotor of the motor 51 so as to determine a rotational speed of the motor 51, and to send to the controller 8 a motor-rotational-speed indicator that indicates the rotational speed of the motor 51.

The motor-current detecting circuit 75 and the sensing resistor 79 (which is implemented as a shunt resistor) are configured to cooperatively detect an electric current of the motor 51. The motor-current detecting circuit 75 is further configured to generate a voltage that corresponds to a value of the electric current of the motor 51 based on detection, and to send the voltage thus generated to the controller 8 so as to enable the controller 8 to monitor the electric current of the motor 51. For example, the controller 8 is capable of controlling the driving circuit 52 to stop operation of the motor 51 in response to an excessive large electric current of the motor 51, thereby providing an over current protection.

Referring to FIGS. 1, 3, and 7, the trigger detecting circuit 76 is electrically connected to the controller 8. The trigger detecting circuit 76 is configured to detect a state of how the trigger 3 is pressed (e.g., whether or not the trigger 3 is pressed, or a depth to which the trigger 3 is pressed), and to send to the controller 8 a trigger-state indicator that indicates the state of how the trigger 3 is pressed so as to enable the controller 8 to determine the state of how the trigger 3 is pressed. In this embodiment, the controller 8 is configured to control, via the driving circuit 52, the motor 51 to rotate at a consistent rotational speed when the trigger detecting circuit 76 detects that the trigger 3 is being pressed, regardless the depth to which the trigger 3 is pressed. Specifically, when the user presses the trigger 3, the controller 8 is configured to continuously output to the driving circuit 52 the PWM signal that has a constant duty ratio as shown in FIG. 7 so as to enable the driving circuit 52 to control the motor 51 to rotate at the consistent rotational speed, regardless the depth to which the trigger 3 is pressed.

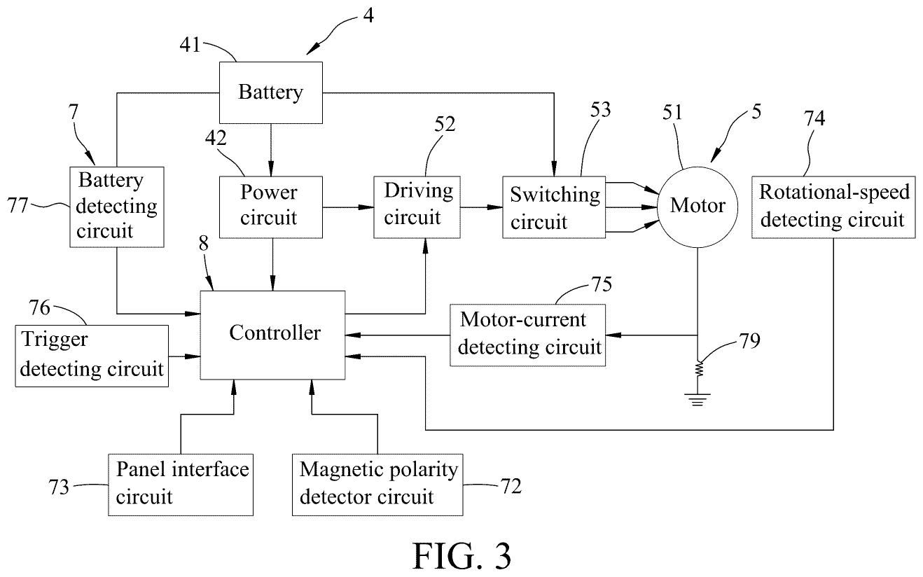

Referring to FIGS. 1 and 3, the battery detecting circuit 77 is electrically connected between the battery 41 and the controller 8. The battery detecting circuit 77 is configured to detect a voltage of the battery 41, and to send to the controller 8 a battery-voltage indicator that indicates the voltage of the battery 41. The controller 8 is configured to adjust, based on the voltage indicated by the battery-voltage indicator, the duty ratio of the PWM signal that is to be outputted to the driving circuit 52 for controlling the motor 51. In this way, the motor 51 is capable of rotating at the preset rotational speed when the electric power tool is in a no-load condition, regardless the voltage of the battery 41.

Referring to FIGS. 3, 4, and 6, the controller 8 is electrically connected to the motor 51 and the magnetic polarity detector circuit 72. The controller 8 may be implemented by a processor, a central processing unit (CPU), a microprocessor, a micro control unit (MCU), a system on a chip (SoC), or any circuit configurable/programmable in a software manner and/or hardware manner to implement functions (e.g., analog-to-digital, A/D, conversion, input/output, I/O, detection, PWM output, rotational-speed computation, and so on) discussed in this disclosure. The controller 8 is configured, when the magnetic ring 71 synchronously rotates with the output shaft 64 that is driven by operation of the motor 51, to control the motor 51 to stop operating when an inter-change time interval between two occurrence time spots at which two respective changes of magnetic polarities were detected by the magnetic polarity detector circuit 72 satisfies a predetermined condition. The predetermined condition is that the inter-change time interval is not smaller than a preset time (e.g., one millisecond or a time period that is greater than one microsecond). The preset time is exemplarily indicated as “t” in FIG. 6. A condition that the inter-change time interval is not smaller than the preset time means that the electric power tool has tightened the fastener with a predetermined level of torque. Oppositely, a condition that the inter-change time interval is smaller than the preset time means that the electric power tool has not yet tightened the fastener with the predetermined level of torque. The controller 8 is configured to start timing the inter-change time interval immediately after the motor 51 starts operating, and each time when the magnetic polarity detector circuit 72 detects a change of magnetic polarities, to reset the inter-change time interval.

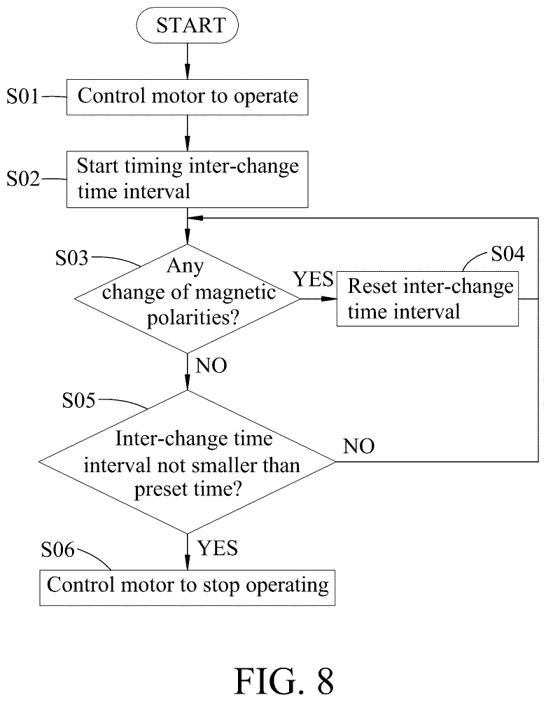

Referring to FIG. 8, an embodiment of a procedure of operating the electric power tool according to the disclosure is illustrated. The procedure includes steps S01 to S06 delineated below.

In the beginning, after the battery 51 is installed in the electric power tool, the battery 51 supplies electricity to the power circuit 42, the driving unit 5, the detection unit 7, and the controller 8. After receiving the electricity supplied by the battery 51, the controller 8 is powered up and then is awaken, and is configured to receive the setting data related to configuring the electric power tool to operate in the operation mode selected by the user, and to determine occurrence of any abnormality in the electric power tool based on messages (e.g., the voltage of the battery 41, the value of the electric current of the motor 51, the state of how the trigger 3 is pressed, the operation mode selected by the user, and so on) outputted by the detection unit 7. In response to the trigger 3 being pressed, steps S01 and S02 are executed almost at the same time.

In step S01, the controller 8 controls the motor 51 to operate.

In step S02, the controller 8 starts timing the inter-change time interval.

When the motor 51 operates, the magnetic ring 71 synchronously rotates with the output shaft 64 as shown in FIG. 2, and the magnetic polarity detector circuit 72 generates and outputs the detection signal that has the waveform as shown in FIG. 6.

In step S03, the controller 8 determines, based on the detection signal outputted by the magnetic polarity detector circuit 72, whether there is any change of magnetic polarities. When a result of the determination is affirmative, a flow of procedure proceeds to step S04. Otherwise, when the result of the determination is negative, the flow proceeds to step S05.

In step S04, the controller resets the inter-change time interval. That is to say, each time a transition (as indicated by an arrow in FIG. 6) of the waveform of the detection signal appears, the inter-change time interval is reset to zero.

In step S05, the controller 8 determines whether the inter-change time interval is not smaller than the preset time. When it is determined that the inter-change time interval is not smaller than the preset time, the flow proceeds to step S06. On the other hand, the flow proceeds to step S03 where the motor 51 keeps operating.

In step S06, the controller 8 controls the motor 51 to stop operating.

In sum, for the electric power tool according to the disclosure, the magnetic polarity detector circuit 72 detects a change of magnetic polarities caused by the magnetic ring 71 that is sleeved on the output shaft 64 and that synchronously rotates with the output shaft 64, and generates the detection signal based on the detection. The controller 8 determines whether the fastener has been tightened with the predetermined level of torque by making, based on the detection signal, the determination as to whether the inter-change time interval is not smaller than the preset time. When it is determined that the inter-change time interval is not smaller than the preset time, i.e., the fastener has been tightened with the predetermined level of torque, the controller 8 controls the motor 51 to stop operating. In this way, a situation that a work piece is broken due to overtightening the fastener may be prevented. Unlike conventional approaches that involve complicated computations, the electric power tool only involves a determination of the inter-change time interval and an uncomplicated comparison between the inter-change time interval and the preset time. Therefore, computational load may be reduced or efficiency of operation of the electric power tool may be improved. Last but not least, a rotational condition of the output shaft 64 may be determined directly based on the detection of the change of magnetic polarities caused by the magnetic ring 71. Therefore, precision of controlling the electric power tool may be improved based on the rotational condition of the output shaft 64 thus determined.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric power tool, comprising:
a housing;
a motor disposed in said housing;
an output shaft connected to said motor and extending out of said housing, and configured to be driven by operation of said motor to rotate about its own axis;
a magnetic ring sleeved on said output shaft so as to synchronously rotate with said output shaft, and having a plurality of magnetic portions surrounding said output shaft, every adjoining two of said magnetic portions having different magnetic polarities;
a magnetic polarity detector circuit disposed at a predetermined position in proximity to said magnetic ring, and configured to detect a change of magnetic polarities at the predetermined position; and
a controller electrically connected to said motor and said magnetic polarity detector circuit, and configured, when said magnetic ring synchronously rotates with said output shaft that is driven by operation of said motor, to control said motor to stop operating when an inter-change time interval between two occurrence time spots at which two respective changes of magnetic polarities were detected by said magnetic polarity detector circuit satisfies a predetermined condition.

2. The electric power tool as claimed in claim 1, wherein the predetermined condition is that the inter-change time interval is not smaller than a preset time.

3. The electric power tool as claimed in claim 1, wherein said controller is configured to start timing the inter-change time interval immediately after said motor starts operating, and each time when said magnetic polarity detector circuit detects a change of magnetic polarities, to reset the inter-change time interval.

4. The electric power tool as claimed in claim 1, further comprising a circuit board that is disposed at the predetermined position, said magnetic polarity detector circuit being disposed on said circuit board.

5. The electric power tool as claimed in claim 1, further comprising:
a trigger disposed on said housing; and
a trigger detecting circuit electrically connected to said controller, and configured to detect a state of how said trigger is pressed,
wherein said controller is configured to control said motor to rotate at a consistent rotational speed when said trigger detecting circuit detects that said trigger is being pressed, regardless a depth to which said trigger is pressed.
